(19) United States
(12) Patent Application Publication
(10) Pub. No.: US 2013/0234921 A1
(43) Pub. Date: Sep. 12, 2013

(54) Reflection-Light Backlight Module and LCD Device

(71) Applicant: Guofu Tang, Shenzhen (CN)

(72) Inventor: Guofu Tang, Shenzhen (CN)

(21) Appl. No.: 13/503,847

(22) PCT Filed: Mar. 31, 2012
(86) PCT No.: PCT/CN12/73391

§ 371 Date: Apr. 24, 2012

(30) Foreign Application Priority Data
Mar. 6, 2012 (CN) 201210056823.7

(51) Int. Cl. G09G 3/36; F21V 13/02

(52) U.S. Cl. 345/102; 362/609

(57) ABSTRACT

The invention provides a reflection-light backlight module and an LCD device. The backlight module includes an LGP, and a reflector arranged on the light incident surface of the LGP. The reflector includes a reflection part, a first extension part which is connected with the front end of the reflection part, and a second extension part which is connected to the back end of the reflection part and arranged opposite to the first extension part. The first extension part and the second extension part clamp the LGP from the light emitting side of the LGP and the other side opposite to the light emitting side. In the invention, because the outer edge of the reflection part of the reflector of the backlight module is provided with an extension part used for shading light, the gap between the edge of the reflection part of the reflector and the light incident surface of the LGP is shaded. Thus, light is prevented from leaking from the gap, and the utilization rate of the light source is increased. Therefore, the brightness of the backlight module and the display effect of the LCD device are increased.

### TECHNICAL FIELD

The invention relates to the field of liquid crystal displays (LCDs), and more particularly to a reflection-light backlight module and an LCD device.

### BACKGROUND

Because of the advantages of small volume, light weight, small thickness, and low consumption, LCDs have been greatly developed in recent years. Being a passive electronic display device, an LCD device employs a backlight module to provide a light source. The backlight module is divided into a direct-light backlight module and an edge-light backlight module in accordance with the light incident mode. The edge-light backlight module includes a light guide panel and a light emitting diode (LED) lightbar arranged on the side of the light guide panel. The LED lightbar is used as a light source of the backlight module.

FIG. 1 shows a reflection-light backlight module. A reflector 100 is used in the structure of the reflection-light module. The reflector 100 includes two parts; one part is a reflection part 110, the inside surface of the reflection part 110 is a reflection surface 111, and the reflection surface 111 is used for reflecting the light emitted by an LED 320 into a light guide panel (LGP) 400; the other part is a horizontal extension part 120 is used for receiving an LED lightbar 300 and a printed circuit board (PCB) 310 thereon.

Because the reflector 100 is generally made of thin material, the stability of the size of an opening (a notch formed by bending the reflection part 110 relative to the extension part 120) is poor. The edge of the reflection part 110 obliquely arranged on the reflector 100 is provided with a small folding wall 112 inserting into an opening 210 of a shielding part 201 of a rubber frame 200, and the rubber frame 200 is also formed with an inclined surface 220 of which the shape is similar to the inclined shape of the reflection part 110 on the back of the reflection part 110 of the reflector 100, to limit the deformation of the reflection part 110 of the reflector 100, and also limit the size variation of the opening of the reflector 100.

The structure has the advantage of easy assembly, namely the parts are only stacked one by one. However, because a gap is still reserved between the reflector 100 and the LGP 400, the rubber frame 200 is positioned by clamping hooks, a distance is reserved between the clamping hooks because of the requirement of structure design, and partial clamping hooks are not closely clamped because of the process capability tolerance factor. Thus, the rubber frame 200 cannot effectively press the LGP 400. Therefore, partial light is emitted from the gap between the reflector 100 and the LGP 400, resulting in light leakage.

### SUMMARY

In view of the above-described problems, the aim of the invention is to provide a reflection-light backlight module and an LCD device with a high light utilization rate.

The aim of the invention is achieved by the following technical scheme. A reflection-light backlight module comprises an LGP, and a reflector arranged on the light incident surface of the LGP; the reflector comprises a reflection part, a first extension part which is connected with the front end of the reflection part, and a second extension part which is connected to the back end of the reflection part and arranged opposite to the first extension part; the first extension part and the second extension part clamp the LGP from the light emitting side of the LGP and the other side opposite to the light emitting side.

Preferably, the joint of the second extension part and the reflection part is provided with a limit part for limiting the position of the LGP. Thus, the positioning reliability of the LGP is increased, and the LGP is limited by the limit part when heat expansion occurs so that the LGP cannot knock and damage the LED.

Preferably, the inside surface of the limit part is in parallel with the light incident surface of the LGP. Mutually parallel interference enables the limit part to limit the position more reliably.

Preferably, the reflection surface of the reflection part comprises a plurality of planes with different inclination angles. The plurality of planes side by side with different inclination angles are selected in accordance with the light angle of the LED, to enable the reflection surface to reflect the light of the LED into the LGP to a maximum extent, thereby avoiding the light loss caused by multiple reflection.

Preferably, the reflection surface of the reflection part is a concave curved surface. The concave curved surface has good reflection and condensation effects.

Preferably, the backlight module comprises a PCB, and a reflection sheet; components clamped between the first extension part and the second extension part of the reflector comprise the PCB, the reflection sheet, and the LGP. The PCB, the reflection sheet and the like are directly integrated via the reflector without fixing the PCB by other parts, thereby saving materials and processes.

Preferably, the backlight module comprises a PCB, and a reflection sheet; components clamped between the first extension part and the second extension part of the reflector comprise the reflection sheet and the LGP. The PCB is arranged below the first extension part, and the first extension part is provided with a through hole for receiving the LED on the PCB. The PCB is arranged below the reflector, thereby reducing the number of the components clamped by the reflector, and then reducing the opening of the reflector. Thus, the phenomenon can be avoided that effective clamping and shading effects cannot be effectively formed because the structural strength of the reflector is influenced by the oversize opening, and the reliability of the reflector can be improved.

Preferably, the backlight module comprises a backplane; the backplane is provided with an opening for fixing the PCB, and the PCB is fixed on the backplane. Thus, the PCB can be stably fixed inside the backlight module, thereby providing a reliable light source.

Preferably, the first extension part is riveted with a bolt in the position corresponding to a screw hole, and the PCB is locked between the backplane and the first extension part by the bolt. The PCB is locked from both sides, so that the fixing reliability of the PCB is increased, and the PCB is more accurately positioned relative to the reflector. Thus, the LED on the PCB is positioned in an optimum position.

Preferably, the end of the second extension part is provided with a bent clamping hook, and the PCB is fixed below the second extension part by the clamping hook. Thus, the assembly procedure of the PCB is saved, and thus the production efficiency is improved.

Preferably, the backlight module comprises an optical film; the optical film is arranged on the second extension part. Therefore, the distance between the optical film and the light emitting surface of the LGP is reduced, thereby reducing the light loss, and increasing the brightness of the backlight module.

Preferably, the reflector is made of metal material with good heat conductivity or plastic material with high reflectance. The reflector made of metal material has good heat-conducting property and reduces temperature, and the reflector made of plastic material has low cost.

A liquid crystal display device comprises the aforementioned backlight module.

In the invention, because the outer edge of the reflection part of the reflector of the backlight module is provided with an extension part used for shading light, the gap between the edge of the reflection part of the reflector and the light incident surface of the LGP is shaded; thus, light is prevented from leaking from the gap, and the utilization rate of the light source is increased. Therefore, the brightness of the backlight module and the display effect of the LCD device are increased.

### BRIEF DESCRIPTION OF FIGURES

FIG. 1 is a simplified structure diagram of a conventional reflection-light backlight module;

FIG. 2 is a simplified structure diagram of a backlight module of a first example of the invention;

FIG. 3 is a simplified structure diagram of a reflector of a backlight module of a first example of the invention;

FIG. 4 is a simplified structure diagram of a backlight module of a second example of the invention;

FIG. 5 is a simplified structure diagram of a first reflector of a backlight module of a second example of the invention;

FIG. 6 is a simplified structure diagram of a second reflector of a second example of the invention;

FIG. 7 is a simplified structure diagram of a third reflector of a second example of the invention;

FIG. 8 is a simplified structure diagram of a reflector with a reflection surface which is a concave curved surface of the invention; and

FIG. 9 is a simplified structure diagram of a reflector with a reflection surface comprising a plurality of planes of the invention.

Legends: 100. reflector; 110. reflection part; 111. reflection surface; 120 first extension part; 130. second extension part; 140. limit part; 170. clamping hook; 180. through hole; 200. rubber frame; 201. shading part; 300. lightbar; 310. PCB; 320. LED; 350. reflection sheet; 360. double-sided adhesive tape; 400. LGP; 410. light emitting surface; 420. optical film; 500. backplane; 510. screw; 520. bolt.

### DETAILED DESCRIPTION

The invention will further be described in detail in accordance with the figures and the preferred examples.

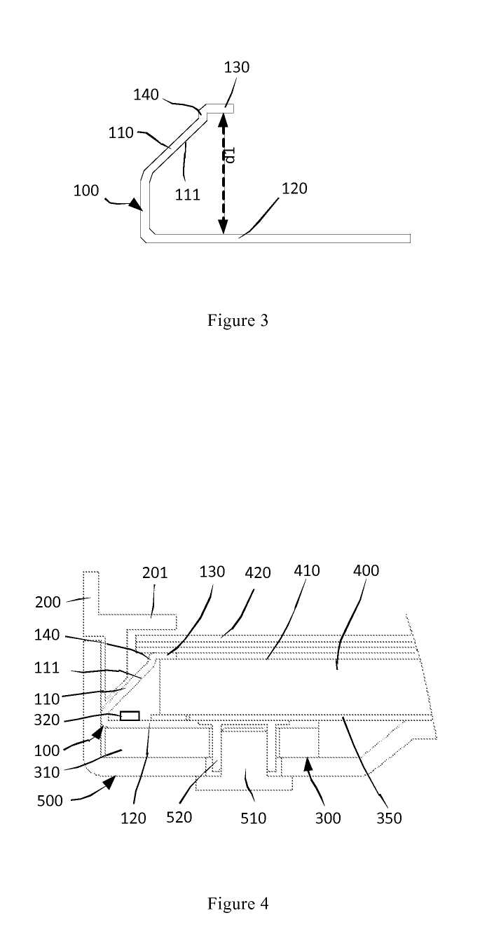

FIG. 2 and FIG. 3 show a reflection-light backlight module of a LCD device. The backlight module comprises a backplane 500, a lightbar 300 arranged in the backplane 500, an LGP 400, and a reflector 100 which is used for reflecting the light emitted by the LED 320 on the lightbar 300 into the LGP 400. A rubber frame 200 tightly presses the reflector 200, the LGP 400, and the optical film arranged on the light emitting surface of the LGP 400 to limit the position of the LGP 400. The reflector 100 comprises a reflection part 110. The inside surface of the reflection part 110 is a reflection surface 111, and the reflection surface 111 is obliquely arranged relative to the light incident surface of the LGP 400. The reflector 100 further comprises a first extension part 120 which is connected to the front end of the reflection part 110, and a second extension part 130 which is connected with the back end of the reflection part 110 and arranged opposite to the first extension part 120. The first extension part 120 and the second extension part 130 clamp the LGP 400 from the light emitting side of the LGP 400 and the other side opposite to the light emitting side; namely the first extension part 120 and the second extension part 130 clamp a plurality of components comprising the LGP 400, and the distance between the first extension part 120 and the second extension part 130 is less than the thickness of the plurality of components clamped by the two extension parts.

The following examples are the specific examples of the invention:

### Example 1

FIG. 2 shows a first example of the invention. The Figure shows a reflection-light backlight module of a LCD device. The backlight module comprises a backplane 500, a lightbar 300 arranged in the backplane 500, an LGP 400, and a reflector 100 which is used for reflecting the light emitted by the LED 320 on the lightbar 300 into the LGP 400. A rubber frame 200 tightly presses the reflector 200, the LGP 400, and the optical film arranged on the light emitting surface of the LGP 400 to limit the position of the LGP 400. The reflector 100 comprises a reflection part 110, and the inside surface of the reflection part 110 is a smooth reflection surface 111. The reflection surface 111 is obliquely arranged relative to the light incident surface of the LGP 400, and the inclination angle between the reflection surface 111 and the LGP 400 is set to an optimal angle in accordance with the light angle of the LED 310 to achieve the optimal reflection efficiency. The reflector 100 further comprises a first extension part 120 which is connected to the front end of the reflection part 110, and a second extension part 130 which is connected with the back end of the reflection part 110 and is arranged opposite to the first extension part 120. The first extension part 120 and the second extension part 130 clamp the components comprising the PCB 310, the reflection sheet 350, the LGP 400 and the like. The PCB 310 is stuck on the first extension part 120 by a double-sided adhesive tape 360 or glue. As shown in FIG. 3, the opening distance between the first extension part 120 and the second extension part 130 is d1, and the opening distance d1 is less than the total thickness of the PCB 310, the reflection sheet 350, the LGP 400 and the like which are stacked together. Thus, the reflector 100 can form effective clamping force, to closely clamp the PCB 310, the reflection sheet 350, the LGP 400 and the like together. Therefore, a light leakage gap between the reflector 100 and the LGP 400 is avoided, and the utilization rate of the light source of the backlight module is increased. Thus, the brightness of the backlight module and the display effect of the LCD device are increased. Furthermore, a complicated mode, for example, using screws, etc. to fix the lightbar 300, is omitted.

As shown in FIG. 2 and FIG. 3, on the reflector 100, the joint of the reflection part 110 and the second extension part 130 is provided with a limit part 140 which is used for limiting the position of the LGP 400, and the inside surface of the limit part 140 is in parallel with the light incident surface of the LGP 400. The installation accuracy of the LGP 400 can be increased via the limiting function of the limit part 140, and the LGP 400 can be limited by the limit part 140 when heat expansion occurs so that the LGP 400 cannot knock and damage the LED 320.

### Example 2

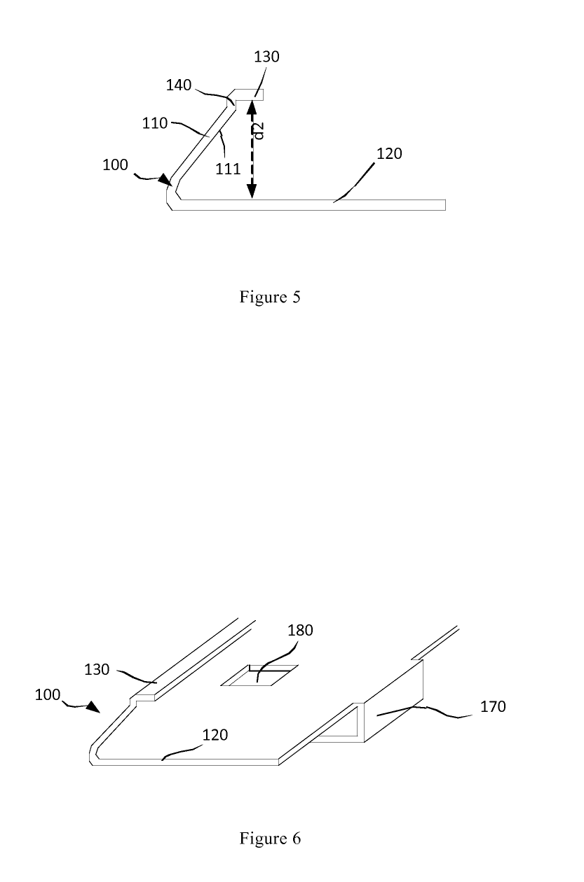

FIG. 4 shows a second example of the invention. The second example is different from the first example in that: FIG. 5 shows a reflector 100 of the second example, the opening distance d2 of the reflector 100 is less than the opening distance d1 of the first example, and the reason is that: as shows in FIG. 4, the components clamped by the reflector 100 comprise the reflection sheet 350, and the LGP 400; the PCB 310 is arranged below the first extension part 120, the first extension part 120 is provided with a through hole for receiving the LED 320 on the PCB 310, and the LED 320 is arranged in the reflector 100 via the through hole. Thus, the opening distance d2 of the reflector 100 is reduced as far as possible, and the structural strength of the reflector 100 is increased, thereby increasing the clamping force of the reflector 100. Therefore, the reflector 100 is closely attached to the LGP 400, the gap is avoided, and thus the light utilization rate of the backlight module and the brightness of the backlight module are increased.

For the second example, it is necessary to consider the fixing mode of the PCB 310. Because the LED 320 is fixed on the PCB 310, the position accuracy and the fixing reliability of the PCB have a direct influence on the light reflection effect of the reflector to the LED 320. As shown in FIG. 4, in the example, the backplane 500 is provided with a screw hole to lock the PCB 310; meanwhile, the corresponding position of the second extension part 120 is welded with a tubular bolt 520, and the PCB 310 is locked between the second extension part 120 and the backplane 500 by a screw 510. The fixing reliability of the PCB 310 is increased, and the PCB 310 is more accurately positioned relative to the reflector. Thus, the LED on the PCB 310 is positioned in an optimum position.

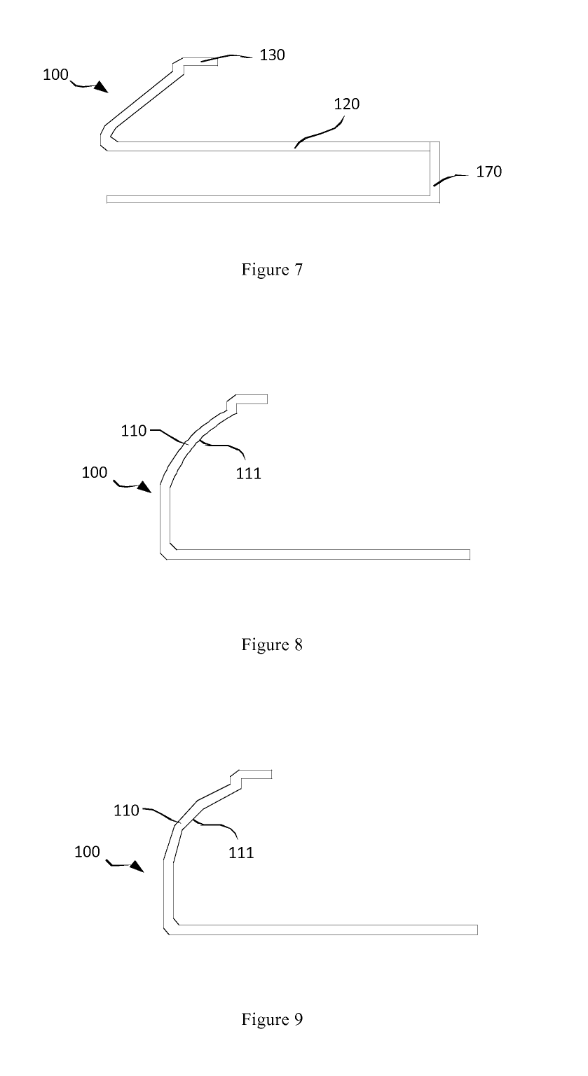

In the second example, as shown in FIG. 6 and FIG. 7, the back end of the first extension part 120 of the reflector 100 is provided with a bent clamping hook 170. The PCB is arranged inside the clamping hook 170 and positioned below the first extension part 120. The first extension part 120 is provided with a through hole 180 for receiving the LED on the PCB. By the mode of directly fixing the PCB by the clamping hook 170, the assembly time of the PCB can be saved.

The above examples are two specific examples of the invention.

In the two examples of the invention, the angle of the reflection surface of the reflector can be set in accordance with the position of the LED, to achieve the optimal reflection efficiency, and avoid the loss of the light source caused by multiple reflections. Similarly, to achieve better focused reflection to enable the light source to be concentrately reflected into the light incident surface of the LGP, the reflection surface of the reflector can be, besides the inclined surface of the first example and the second example, in a shape of the concave curved surface as shown in FIG. 8, or can be in a shape of the reflection surface with a plurality of planes comprising various inclination angles as shown in FIG. 9. The reflection surface of such a shape can concentrately reflect the light of multiple angles into the light incident surface of the LGP.

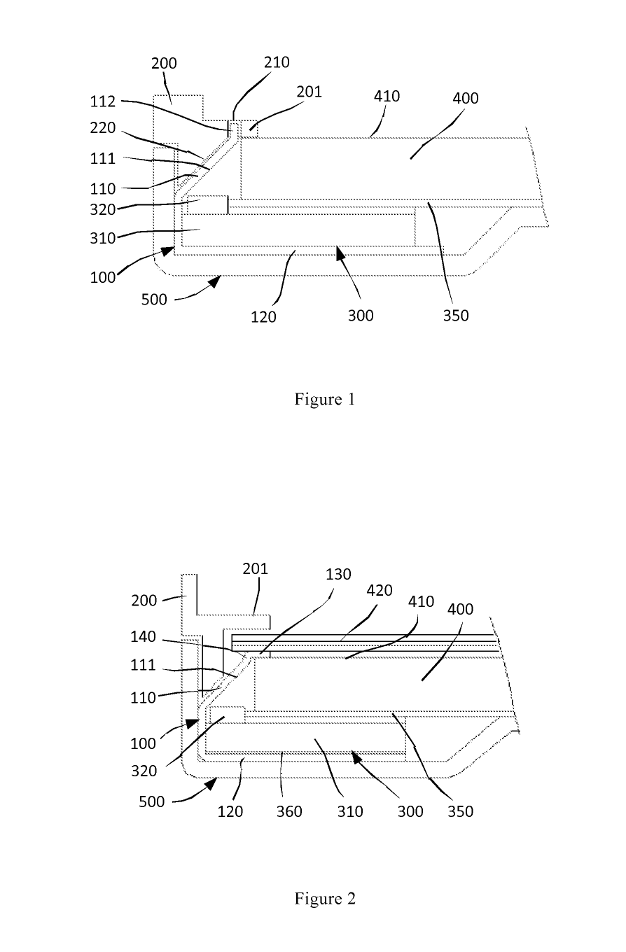

In the two examples of the invention, as shown in FIG. 2 and FIG. 4, the optical film 420 of the backlight module can be arranged on the second extension part 130. Thus, the distance between the optical film 420 and the emitting surface 410 of the LGP 400 will be reduced; therefore, the backlight module can be prevented from losing too much brightness. As shown in FIG. 1, the optical film of the conventional backlight module is arranged above the shading part 201 of the rubber frame 200. However, the shading part 201 is used for providing pressing force in addition to shading light; thus, the thickness of the shading part 201 is large, causing the distance between the optical film and the light emitting surface 410 of the LGP 400 to be far. In the two examples of the invention, the problem has been solved.

In the two examples of the invention, the reflector 100 is made of material with good heat conductivity such as pure aluminum, pure copper, etc., and has higher heat conduction efficiency than that of the backplane. Thus, better heat conduction effect can be obtained, and thus the temperature of the backlight module can be reduced. Of course, considering cost, the reflector can be made of plastic material with lower cost and high reflectance.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. A reflection-light backlight module, comprising: a backplane, a PCB, an LGP, a reflection sheet, and a reflector arranged on the light incident surface of the LGP; wherein said reflector comprises a reflection part, a first extension part which is connected with the front end of the reflection part, and a second extension part which is connected to the back end of the reflection part and arranged opposite to said first extension part; said first extension part and said second extension part clamp said LGP from the light emitting side of said LGP and the other side opposite to said light emitting side; the joint of said second extension part and said reflection part is provided with a limit part for limiting the position of said LGP; components clamped between the first extension part and the second extension part of said reflector comprise the reflection sheet, and the LGP; said PCB is arranged below said first extension part, said first extension part is provided with a through hole for receiving the LED on said PCB, said backplane is provided with an opening for fixing said PCB, and said PCB is fixed on said backplane.

2. A reflection-light backlight module, comprising: an LGP, and a reflector arranged on the light incident surface of the LGP; wherein said reflector comprises a reflection part, a first extension part which is connected with the front end of said reflection part, and a second extension part which is connected to the back end of said reflection part and arranged opposite to said first extension part;
said first extension part and said second extension part clamp said LGP from the light emitting side of said LGP and the other side opposite to said light emitting side.

3. The reflection-light backlight module of claim 2, wherein the joint of said second extension part and said reflection part is provided with a limit part for limiting the position of said LGP.

4. The reflection-light backlight module of claim 3, wherein the inside surface of said limit part is in parallel with the light incident surface of said LGP.

5. The reflection-light backlight module of claim 2, wherein the reflection surface of said reflection part comprises a plurality of planes with different inclination angels.

6. The reflection-light backlight module of claim 2, wherein the reflection surface of said reflection part is a concave curved surface.

7. The reflection-light backlight module of claim 2, wherein said backlight module comprises a PCB, and a reflection sheet; components clamped between the first extension part and the second extension part of said reflector comprise the PCB, the reflection sheet, and the LGP.

8. The reflection-light backlight module of claim 2, wherein said backlight module comprises a PCB, and a reflection sheet; components clamped between the first extension part and the second extension part of said reflector comprise the reflection sheet, and the LGP; said PCB is arranged below said first extension part, and said first extension part is provided with a through hole for receiving the LED on said PCB.

9. The reflection-light backlight module of claim 8, wherein said backlight module comprises a backplane; said backplane is provided with an opening for fixing said PCB, and said PCB is fixed on said backplane.

10. The reflection-light backlight module of claim 9, wherein said first extension part is riveted with a bolt in the position corresponding to a screw hole, and said PCB is locked between said backplane and said first extension part by said bolt.

11. The reflection-light backlight module of claim 8, wherein the back end of said second extension part is provided with a bent clamping hook, and said PCB is fixed below said second extension part by said clamping hook.

12. The reflection-light backlight module of claim 2, wherein said backlight module comprises an optical film; said optical film is arranged on said second extension part.

13. The reflection-light backlight module of claim 2, wherein said reflector is made of metal material with good heat conductivity or plastic material with high reflectance.

14. An LCD device, comprising: a backlight module; wherein said backlight module comprises an LGP, and a reflector arranged on the light incident surface of said LGP; said reflector comprises a reflection part, a first extension part which is connected with the front end of said reflection part, and a second extension part which is connected to the back end of said reflection part and arranged opposite to said first extension part; said first extension part and said second extension part clamp said LGP from the light emitting side of said LGP and the other side opposite to said light emitting side.

15. The LCD device of claim 14, wherein the joint of said second extension part and said reflection part is provided with a limit part for limiting the position of said LGP.

16. The LCD device of claim 15, wherein the inside surface of said limit part is in parallel with the light incident surface of said LGP.

17. The LCD device of claim 14, wherein said backlight module comprises a PCB, and a reflection sheet; components clamped between the first extension part and the second extension part of said reflector comprise the PCB, the reflection sheet, and the LGP.

18. The LCD device of claim 14, wherein said backlight module comprises a PCB, and a reflection sheet; components clamped between the first extension part and the second extension part of said reflector comprise the reflection sheet, and the LGP; said PCB is arranged below said first extension part, and said first extension part is provided with a through hole for receiving the LED on said PCB.

19. The LCD device of claim 18, wherein said backlight module comprises a backplane; said backplane is provided with an opening for fixing said PCB, and said PCB is fixed on said backplane.

20. The LCD device of claim 18, wherein the back end of said second extension part is provided with a bent clamping hook, and said PCB is fixed below said second extension part by said clamping hook.
